(19) United States
(12) Patent Application Publication
(10) Pub. No.: US 2020/0198005 A1
(43) Pub. Date: Jun. 25, 2020

(54) ADDITIVE MANUFACTURING USING TWO OR MORE SOURCES OF ATOMIZED METAL PARTICLES

(71) Applicant: GM GLOBAL TECHNOLOGY OPERATIONS LLC, Detroit, MI (US)

(72) Inventors: Zhe Li, Rochester, MI (US); Shekhar G. Wakade, Grand Blanc, MI (US)

(21) Appl. No.: 16/231,674

(22) Filed: Dec. 24, 2018

(51) Int. Cl. B22F 3/00; B33Y 10/00; B29C 64/165; B22F 9/08

(52) U.S. Cl. CPC B22F 3/008; B33Y 10/00; B33Y 80/00; B22F 9/082; B29C 64/165

(57) ABSTRACT

A method of additively manufacturing a monolithic metal article having a three-dimensional shape is disclosed. The method involves forming a preform of the article that includes atomized metal particles bound together by a binder material. The atomized metal particles, more specifically, comprises (1) water atomized metal particles and (2) gas atomized metal particles, plasma atomized metal particles, or a mixture of gas atomized metal particles and plasma atomized metal particles. The water atomized metal particles may be contained in one portion of the preform and the gas and/or plasma atomized metal particles may be contained in another portion of the preform. The method also includes removing at least a portion of the binder material from the preform and sintering the preform to transform the preform into the monolithic metal article.

### INTRODUCTION

Additive manufacturing (AM) refers to class of computer-aided manufacturing processes in which a three-dimensional metal article is built layer-by-layer to its final geometric shape using digital design data to coordinate the incremental creation of the article. One type of AM process is known as bound metal deposition. In bound metal deposition, an extrudable thermoplastic deposition medium, which includes metal particles dispersed within a binder material, is heated and then repeatedly and consecutively deposited one individual cross-sectional layer at a time to form a preform of the metal article being produced. The preform, once complete, is an enlarged replica of the final intended metal article and is comprised of the accumulated metal particles and binder material that have been deposited, with the binder material physically binding the metal particles together into a “green part.” The preform then undergoes a debinding procedure in which at least some of the binder material is removed to leave the preform is a porous, semi-fragile state typically referred to as a “brown part.” At this point, the preform is sintered via heating to remove any remaining binder material and to fuse the metal particles together. During sintering, the preform densifies, shrinks, and transforms into the metal article. Current bound metal deposition techniques, however, are not able to quickly and efficiently fabricate metal articles that possess non-uniform metal compositions, physical properties, and/or mechanical properties.

### SUMMARY OF THE DISCLOSURE

A method of additively manufacturing a monolithic metal article having a three-dimensional shape according to practices of the present disclosure includes several steps. In one step, a preform of the article is formed that includes atomized metal particles bound together by a binder material. The atomized metal particles comprise (1) water atomized metal particles and (2) gas atomized metal particles, plasma atomized metal particles, or a mixture of gas atomized metal particles and plasma atomized metal particles. In another step, at least some of the binder material is removed from the preform. And, in yet another step, the preform is sintered to remove any remaining binder material and to fuse the metal particles together in the solid state to thereby densify and transform the preform into the monolithic metal article.

The aforementioned method may include additional steps or be further defined. For example, the water atomized metal particles may be composed of one of steel, iron, iron-carbon alloy, aluminum alloy, cobalt alloy, copper, brass, bronze, tin, zinc, cadmium, tungsten, titanium, or rhenium, and, likewise, the gas atomized metal particles, plasma atomized metal particles, or the mixture of gas atomized metal particles and plasma atomized metal particles may be composed of one of steel, iron, iron-carbon alloy, aluminum alloy, cobalt alloy, copper, brass, bronze, tin, zinc, cadmium, tungsten, titanium, or rhenium. The water atomized metal particles and the gas atomized metal particles, plasma atomized metal particles, or the mixture of gas atomized metal particles and plasma atomized metal particles may be composed of the same metal. Alternatively, the water atomized metal particles and the gas atomized metal particles, plasma atomized metal particles, or the mixture of gas atomized metal particles and plasma atomized metal particles may be composed of different metals. In one implementation of the method, the monolithic metal article may be an automotive component part selected from the group consisting of a cylinder liner, an intake valve, an exhaust valve, a piston, a connecting rod, a piston ring, an engine block, a transmission housing, a gear shaft, a sleeve, and a washer.

Additionally, the step of forming the preform may include depositing a first set of consecutive cross-sectional layers of the preform to form a first portion of the preform. Each of the cross-sectional layers of the first set is deposited from a first extrudable deposition medium. Similarly, the step of forming the preform may include depositing a second set of consecutive cross-sectional layers of the preform to form a second portion of the preform adjacent to and contiguous with the first portion of the preform. Each of the cross-sectional layers of the second set is deposited from a second extrudable deposition medium. Furthermore, the first extrudable deposition medium or the second extrudable deposition medium comprises water atomized metal particles, and the other of the first deposition medium or the second deposition medium comprises gas atomized metal particles, plasma atomized metal particles, or a mixture of gas atomized metal particles and plasma atomized metal particles. The step of forming the preform may, if desired, further include depositing a third set of consecutive cross-sectional layers of the preform to form a third portion of the preform adjacent to and contiguous with the second portion of the preform. Each of the cross-sectional layers of the third set is deposited from the first extrudable deposition medium or from a third extrudable deposition medium that is different from the first and second extrudable deposition mediums.

Another method of additively manufacturing a monolithic metal article having a three-dimensional shape according to practices of the present disclosure may include several steps. In one step, a preform of the article is formed by consecutively depositing a plurality of cross-sectional layers of the preform to thereby build the preform layer-by-layer upwardly from a build surface. The preform comprises atomized metal particles bound together by a binder material and, further, the preform includes a first portion and a second portion that is adjacent to and contiguous with the first portion. The first portion or the second portion comprises water atomized metal particles, and the other of the first portion or the second portion comprises gas atomized metal particles, plasma atomized metal particles, or a mixture of gas atomized metal particles and plasma atomized metal particles. In another step, at least some of the binder material is removed from the preform. And, in yet another step, the preform is sintered to remove any remaining binder material and to fuse the metal particles together in the solid state to thereby densify and transform the preform into the monolithic metal article.

The aforementioned method may include additional steps or be further defined. For instance, the step of forming the preform may include depositing a first set of consecutive cross-sectional layers of the preform to form the first portion of the preform, and depositing a second set of consecutive cross-sectional layers of the preform to form the second portion of the preform. Each of the cross-sectional layers of the first set is deposited from a first extrudable deposition medium, and each of the cross-sectional layers of the second set is deposited from a second extrudable deposition medium. The first extrudable deposition medium or the second extrudable deposition medium comprises water atomized metal particles, and the other of the first deposition medium or the second deposition medium comprises gas atomized metal particles, plasma atomized metal particles, or a mixture of gas atomized metal particles and plasma atomized metal particles. Additionally, if desired, the step of forming the preform may include depositing a third set of consecutive cross-sectional layers of the preform to form a third portion of the preform adjacent to and contiguous with the second portion of the preform. Each of the cross-sectional layers of the third set is deposited from the first extrudable deposition medium or from a third extrudable deposition medium that is different from the first and second extrudable deposition mediums. In some implementations of the method, each of the plurality of cross-sectional layers of the preform has a thickness ranging from 50 μm to 250 μm. The manufactured monolithic metal article produced from the aforementioned method includes a first region derived from the first portion of the preform and a second region derived from the second region of the preform. The first region of the metal article has a density that is different from a density of the second region of the metal article.

Still another method of additively manufacturing a monolithic metal article having a three-dimensional shape according to practices of the present disclosure may include several steps. In one step, a preform of the article is formed that includes metal particles bound together by a binder material. This step involves depositing a first set of consecutive cross-sectional layers of the preform to form a first portion of the preform, and depositing a second set of consecutive cross-sectional layers of the preform to form a second portion of the preform adjacent to and contiguous with the first portion of the preform. Each of the cross-sectional layers of the first set is deposited from a first extrudable deposition medium, and each of the cross-sectional layers of the second set is deposited from a second extrudable deposition medium. The first extrudable deposition medium or the second extrudable deposition medium comprises water atomized metal particles, and the other of the first deposition medium or the second deposition medium comprises gas atomized metal particles, plasma atomized metal particles, or a mixture of gas atomized metal particles and plasma atomized metal particles. In another step, at least some of the binder material is removed from the preform by immersing the preform in a dissolution liquid or by heating the preform. And, in yet another step, the preform is sintered to remove any remaining binder material and to fuse the metal particles together in the solid state to thereby densify and transform the preform into the monolithic metal article.

The aforementioned method may include additional steps or be further defined. For example, the water atomized metal particles are composed of one of steel, iron, iron-carbon alloy, aluminum alloy, cobalt alloy, copper, brass, bronze, tin, zinc, cadmium, tungsten, titanium, or rhenium, and the gas atomized metal particles, plasma atomized metal particles, or the mixture of gas atomized metal particles and plasma atomized metal particles are composed of one of steel, iron, iron-carbon alloy, aluminum alloy, cobalt alloy, copper, brass, bronze, tin, zinc, cadmium, tungsten, titanium, or rhenium. Also, the monolithic metal article produced from the aforementioned method includes a first region derived from the first portion of the preform and a second region derived from the second region of the preform. The first region of the metal article has a density that is different from a density of the second region of the metal article.

### BRIEF DESCRIPTION OF THE DRAWINGS

FIG. 1 is a schematic illustration of an atomization device for producing water atomized metal particles according to one embodiment of the present disclosure;

FIG. 2 is a schematic illustration of an atomization device for producing gas atomized metal particles according to one embodiment of the present disclosure;

FIG. 3 is a schematic illustration of an atomization device for producing plasma atomized metal particles according to one embodiment of the present disclosure;

FIG. 4 is a partial cross-sectional view of a cylinder liner for an engine block of an internal combustion engine, which is an example of a monolithic metal article that can be fabricated by processes of the present disclosure as set forth in more detail in FIGS. 5-8;

FIG. 5 is a schematic illustration of an apparatus for fabricating a preform of a metal article using bound metal deposition technology according to one embodiment of the present disclosure;

FIG. 6 is a partial magnified view of the device illustrated in FIG. 5, which is shown in the context of additively manufacturing a cylinder liner for an internal combustion engine, wherein the device is fabricating a first portion of the preform that includes gas and/or plasma atomized metal particles according to one embodiment of the present disclosure;

FIG. 7 is a partial magnified view of the device illustrated in FIG. 5 operating similar to that shown in FIG. 6, although here the device is fabricating a second portion of the preform that includes water atomized metal particles according to one embodiment of the present disclosure;

FIG. 8 is a partial magnified view of the device illustrated in FIG. 5 operating similar to that shown in FIGS. 6-7, although here the device is fabricating a third portion of the preform that, once again, includes gas and/or plasma atomized metal particles according to one embodiment of the present disclosure; and

FIG. 9 is an elevated cross-sectional view depicting the transformation of a preform of the cylinder liner into the monolithic metal cylinder liner as part of the presently-disclosed bound metal deposition process.

### DETAILED DESCRIPTION

The present disclosure relates to the manufacture of three-dimensionally shaped monolithic metal articles by way of additive manufacturing and, in particular, by way of a variation of bound metal deposition that uses at least two different sources of metal particles to prepare a preform. This permits the metal article derived from the preform to contain regions in which the metal composition, physical properties, and/or mechanical properties are different. The additively manufactured metal article may therefore have certain select characteristics in certain regions based on its intended function, which can allow for the mass and functional performance of the metal article to be better optimized. The monolithic metal article manufactured by the present bound metal deposition process may be any of a wide variety of metal components. For example, the metal article may be an automotive component part that is simple or complex in overall shape and surface contour. Some specific automotive component parts that may be fabricated include a cylinder liner—which is shown in the figures and described below as an illustrative embodiment of the present disclosure—as well as other component parts such as an intake valve, an exhaust valve, a piston, a connecting rod, a piston ring, an engine block, a transmission housing, a gear shaft, a sleeve, and a washer.

To carry out the disclosed bound metal deposition method, the atomized metal particles used to additively manufacture the monolithic metal article are supplied from at least two different sources of atomized metal particles. Whether or not the sources of atomized metal particles are different for purposes of the present disclosure depends on the atomization process employed to produce the metal particles. In general, there are three categories of atomization processes that can produce atomized metal particles: (1) water atomization; (2) gas atomization; and (3) plasma atomization. Atomized metal particles that have been produced by any one of those categories of atomization processes are thus considered to be from a different source than atomized metal particles produced from any of the other two categories of atomization processes. This is true for purposes of the present disclosure even if the atomized metal particles produced by the distinctive atomization processes have the same chemical composition. For example, atomized metal particles produced by gas atomization are considered to be from a different source than atomized metal powders produced by water atomization or plasma atomization, regardless of the composition of the metal particles sourced from each process.

The water atomization, gas atomization, and plasma atomization processes are illustrated broadly in FIGS. 1-3 to help emphasize the differences between the three processes. Referring now to FIG. 1, a water atomization device 10 is illustrated. The water atomization device 10 includes a melt chamber 12 and an atomization chamber 14. In the melt chamber 12, which is usually a standard combustion furnace or a vacuum induction melting furnace, a feedstock metal 16 is melted. The molten feedstock metal 16 is then transferred to a turndish 18, which is a crucible that regulates the flow of the molten feedstock metal 16 into a falling stream 20. The falling stream 20 of molten feedstock metal 16 is released into an interior cavity 22 of the atomization chamber 14 where it is impacted and disintegrated into tiny droplets by multiple high-velocity water jet streams 24 that are aimed at the falling stream 20 from several locations surrounding the falling stream 20. The tiny droplets of the disintegrated molten feedstock metal 16 rapidly solidify into atomized metal particles 26 within the interior cavity 22 of the atomization chamber 14 with the help of high chilling effect of the water. The water atomized particles 26 eventually accumulate in a collection chamber 28 that is filled with water. Because the water atomized metal particles 26 are rapidly quenched with water and solidified, they tend to have an irregular shape (i.e., they are non-spherical) and morphology.

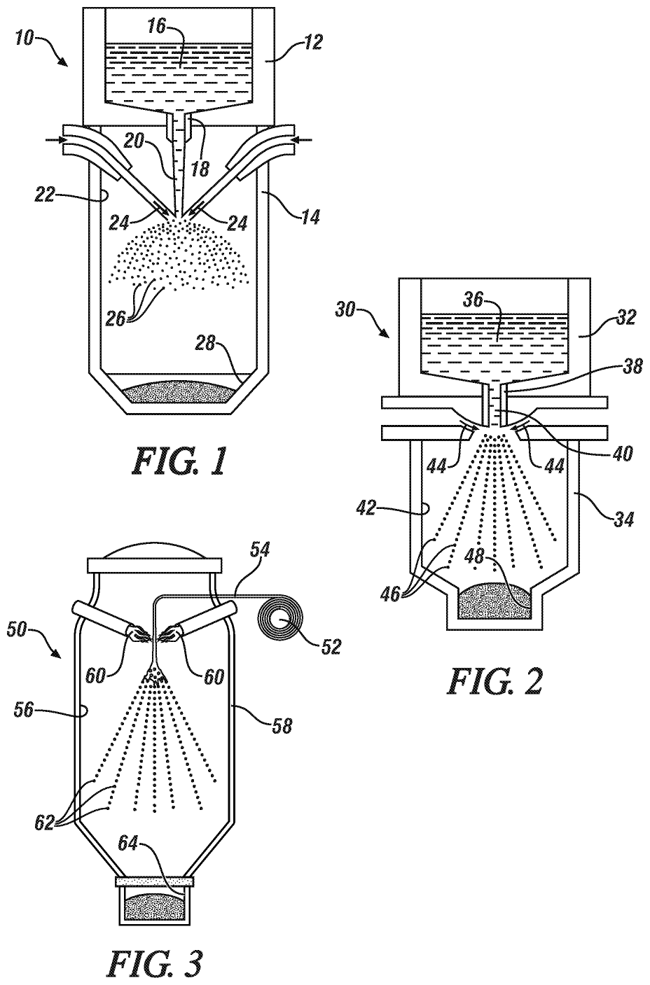

Referring now to FIG. 2, a gas atomization device 30 is illustrated. The gas atomization device 30 is similar to the water atomization device 10 in that it includes a melt chamber 32 and an atomization chamber 34. In the melt chamber 32, which again is usually a standard combustion furnace or a vacuum induction melting furnace, a feedstock metal 36 is melted. The molten feedstock metal 36 is then transferred to a turndish 38 that regulates the flow of the molten feedstock metal 36 into a falling stream 40. The falling stream 40 of molten feedstock metal 36 is released into an interior cavity 42 of the atomization chamber 34 where it is impacted and disintegrated into tiny droplets by multiple high-velocity gas streams 44 that are aimed at the falling stream 40 from several locations surrounding the falling stream 40. The discharged gas in the gas streams 44 may be nitrogen, argon, or air if the risk of oxidation is low, and an inert atmosphere may be maintained in the interior cavity 42 to minimize oxidation of the metal droplets. The tiny droplets of the disintegrated molten feedstock metal 36 rapidly solidify into atomized metal particles 46 within the interior cavity 42 of the atomization chamber 34, but at a slower rate than water atomized metal particles since the discharged gas has a lower heat capacity than water. The relatively slower rate of solidification allows the gas atomized metal particles 46 enough time to contract and undergo spheriodization, thus rendering the particles 46 spherical in shape. The gas atomized particles 46 eventually accumulate in a collection chamber 48 that may or may not (as shown) be filled with water.

Referring now to FIG. 3, a plasma atomization device 50 is illustrated. The plasma atomization device 50 includes a feeder 52, such as a spool, that feeds a feedstock metal 54 in the form of a wire or rod into an interior cavity 56 of an atomization chamber 58. The feedstock metal 54, once fed into the atomization chamber 58, is melted and atomized into tiny droplets by plasma torches 60, for example, argon plasma torches, that are positioned around the feeding path of the feedstock metal 54. Here, similar to gas atomization, an inert atmosphere may be maintained in the interior cavity 56 to minimized oxidation of the metal droplets. The resultant tiny droplets of the molten feedstock metal 54 rapidly solidify into atomized metal particles 62 within the interior cavity 56 of the atomization chamber 58 and eventually accumulate in a collection chamber 64 at the bottom of the atomization chamber 58. Much like the gas atomized particles described above in connection with FIG. 2, the plasma atomized metal particles produced here have sufficient time to undergo spheriodization, thus resulting in the metal particles 62 being spherical in shape. In terms of operating costs, the plasma atomized metal particles 62 and the gas atomized metal particles 46 are more expensive to produce than the water atomized metal particles 26, especially if those processes produce their respective metal particles 46, 62 under an inert gas atmosphere.

In each of the atomization processes described above, the atomized metal particles produced have a distribution of sizes. The collected atomized particles may be separated into a size range that is most suitable for bound metal deposition by a variety of techniques. A simple and reliable technique for obtaining atomized metal particles of a desired size is through sieving. To carry out the presently-disclosed bound metal deposition process, the atomized metal particles—whether produced by way of water atomization, gas atomization, or plasma atomization—preferably have a largest size dimension that ranges from 10 μm to 70 μm or, more narrowly, from 15 μm to 50 μm. Atomized metal particles falling in this size range are generally favored since they possess satisfactory fluidity and can be tightly compacted together during sintering to achieve a high percentage of theoretical density. In that regard, when performing the bound metal deposition process of the present disclosure, the differently-sourced atomized metal particles preferably, but not necessarily, have a particle size distribution within the range of 10 μm to 70.

The bound metal deposition process of the present disclosure involves forming a preform of the article by consecutively depositing a plurality of cross-sectional layers of the preform to thereby build the preform layer-by-layer upwardly from a build surface. Each of the plurality of layers is extruded and deposited from an extrudable deposition medium that includes metal particles dispersed within a binder material. The metal particles included in the extrudable deposition medium may include those of steel, iron, iron-carbon alloy, aluminum alloy, cobalt alloy, copper, brass, bronze, tin, zinc, cadmium, tungsten, titanium, or rhenium, and the binder material may be a mixture of a thermoplastic polymer and wax. At least two different extrudable deposition mediums are used in order to provide the differently-sourced metal particles into the preform at the desired locations. Each of the deposited cross-sectional layers is typically deposited to a thickness that ranges from 50 μm to 250 μm. In addition to the preform, a raft and preform supports may be fabricated beforehand from at least one of the extrudable deposition mediums to support the building process in known fashion.

When forming the preform according to a preferred practice of the present disclosure, at the very minimum, each of a first set of consecutively deposited cross-sectional layers is composed of a first extrudable deposition medium to provide a first portion of the preform and, likewise, each of a second set of consecutively deposited cross-sectional layers is composed of a second extrudable deposition medium to provide a second portion of the preform that is contiguous with and adjacent to the first portion. The first extrudable deposition medium or the second extrudable deposition medium comprises water atomized metal particles, and the other of the first deposition medium or the second deposition medium comprises gas atomized metal particles, plasma atomized metal particles, or a mixture of gas atomized metal particles and plasma atomized metal particles. In this way, the metal particles contained within the first and second portions of the preform are differently-sourced metal particles. The metal particles included in the first and second extrudable deposition mediums may have the same or different compositions. If the metal particles in the two mediums are different, the two types of metal particles should be compatible—that is, the metal that constitutes the metal particles in the first extrudable deposition medium and the metal that constitutes the metal particles in the second extrudable deposition medium can metallurgically bond together and have similar mechanical and thermal properties such as steel-steel (as between different steels), steel-iron, steel-aluminum, and steel-cobalt alloy.

As will be explained in more detail below, the several different portions developed in the preform based on a difference in metal particle sources will ultimately manifest themselves as different regions of the monolithic metal article. These regions are distinguishable by differences in density. In particular, if the metal particles in the first portion of the preform are water atomized and the metal particles in the adjacent second portion are gas and/or plasma atomized, but the compositions of the particles are otherwise the same in both portions (e.g., the water atomized particle sand gas/plasma atomized particles are all composed of the same type of steel), the differences in shape between the water and gas/plasma atomized particles will nonetheless provide their corresponding regions of the metal article with different densities. In another implementation, if the metal particles in the first portion of the preform are composed of one composition, and the metal particles in the adjacent second portion are composed of another composition (e.g., the metal particles in the first portion are steel and the metal particles in the second portion are iron), the differences in shape between the water and gas/plasma atomized particles as well as the differences in mass of the distinct metal particle compositions will provide their corresponding regions of the metal article with different densities.

The preform may include only the first and second portions or, if desired, it may include additional portions. For example, each of a third set of consecutively deposited cross-sectional layers may provide a third portion of the preform that is contiguous with and adjacent to the second portion of the preform. Each of the third set of consecutively deposited cross-sectional layers may be composed of a third extrudable deposition medium that is different from the first and second deposition mediums, or, alternatively, in some implementations, each of the third set of layers may be composed of the first deposition medium if the intent is to sandwich the second portion of the preform between two otherwise identically-composed portions of the preform. The preform may include any number of portions identifiable by the source of the metal particles contained therein. In this way, the monolithic metal article formed by the presently-disclosed bound metal deposition process can have certain select regions that have compositional, physical, and/or mechanical properties tailored for one purpose while other select regions can have composition, physical, and/or mechanical more tailored for another purpose.

Once the preform is formed completely, at which point it is commonly referred to as a “green part,” the preform is subjected to a debinding procedure in which at least some, typically 30 wt % to 70 wt %, of the binder material in the preform is removed. The debinding of the preform may be performed by immersing the preform in a dissolution liquid that can dissolve the binder material. For instance, the dissolution liquid may include acetone, heptane, trichloroethylene, or water, to name but a few examples. Satisfactory debinding may also be carried out in some instances by heating the preform to thermally decompose and drive off at least some of binder material. During debinding, the porosity of the preform increases as the amount of the remaining binding material decreases. When the debinding procedure is complete, the preform, which is now commonly referred to as a “brown part,” is semi-fragile and porous, but is still able to maintain is shape. The preform is then sintered. The sintering of the preform involves heating the preform to near-melting in an oven, a furnace, a lehr, or some other heating device to remove any remaining binder material and to fuse the metal particles together. Notably, during sintering, the preform densifies, shrinks, and transforms into the final monolithic metal article. It is not uncommon for the monolithic metal article to have a volume that is 10-25% less than the preform just prior to sintering.

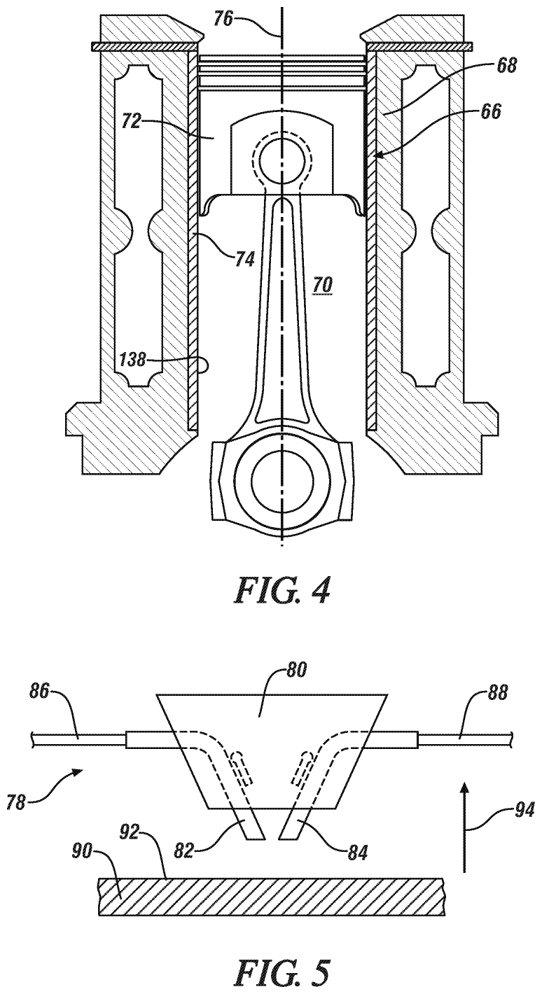

The presently-disclosed bound metal deposition process is exemplified below in the context of the manufacture of a particular automotive component part. Referring now to FIG. 4, the monolithic metal article may be a cylinder liner 66. The cylinder liner 66 is fitted within a bore of an engine block 68 to define a cylinder 70 for accommodating the reciprocal linear movement of a piston head 72 in response to the precisely timed repetitious combustion of an air-fuel mixture at the top of the cylinder 70. The cylinder liner 66, in that regard, includes a cylindrical wall 74 that circumferentially surrounds and extends axially along a central longitudinal axis 76. The engine block 68 that houses the cylinder liner 66 is typically constructed from an aluminum alloy or cast iron, and usually defines anywhere from four to ten of the bores shown here in FIG. 4, although only one such bore is illustrated. Each of the bores may be fitted with the cylinder liner 66 depicted here and described in more detail below. While the following discussion is directed specifically to the cylinder liner 66, it should be appreciated that the same concepts and additive manufacturing techniques may be applied to other automotive component parts including an intake valve, an exhaust valve, a piston, a connecting rod, a piston ring, an engine block, a transmission housing, a gear shaft, a sleeve, and a washer.

Referring now to FIG. 5, a bound metal deposition apparatus 78 for additively manufacturing the cylinder liner 66 by way of bound metal deposition in accordance with practices of the present disclosure is depicted. The apparatus 78 includes a nozzle head 80 that supports a first extruder nozzle 82 and a second extruder nozzle 84. An additional gas nozzle (not shown) may also be supported in the nozzle head 80 to discharge an inert gas such as argon or nitrogen if needed to blanket the build area. The first extruder nozzle 82 is feedable with a first cartridge 86 and the second extruder nozzle 84 is feedable with a second cartridge 88. The first and second cartridges 86, 88 are separate from each other and include differently-sourced metal particles. The nozzle head 80 and each of the first and second extruder nozzles 82, 84 are computer controlled in known fashion so that their movements and extrusion activity can be precisely coordinated to carry out instructions based on programmed digital design data specific to the cylinder liner 66 being manufactured. Additionally, the apparatus 78 includes a build plate 90 that provides a build surface 92. The build surface 92 supports the incremental creation of a preform of the cylinder liner 66 as the nozzle head 80 builds the preform upwardly from the build surface 92 in a building direction 94.

In this embodiment, the first cartridge 86 is comprised of a first extrudable deposition medium that includes gas atomized metal particles and/or plasma atomized metal particles bound by a first binder material, and the second cartridge 88 is comprised of a second extrudable deposition medium that includes water atomized metal particles bound by a second binder material. Each of the first and second cartridges 86, 88 may be in the form of a rod (as shown) or some other handleable and feedable shape. The metal particles included in the first and second cartridges 86, 88 may be the same or different in terms of composition. For example, the metal particles included in the first cartridge 86 may be gas atomized, plasma atomized, or a mixture of gas atomized and plasma atomized steel particles that, as explained above, are spherically shaped, while the metal particles included in the second cartridge 88 may be water atomized particles of the same steel composition. The steel particles in each cartridge 86, 86 may be a 1080 low carbon alloy steel that contains 0.75 wt % to 0.88 wt % carbon along with manganese and, optionally, sulfur and/or phosphorus. In other implementations, the metal particles included in the first cartridge 86 may be steel particles, such as those of the low carbon alloy steel just described, and the metal particles included in the second cartridge 88 may be a different steel alloy, such as a 1010 low carbon alloy steel that contains 0.080 wt % to 0.13 wt % carbon along with manganese and, optionally, sulfur and/or phosphorus.

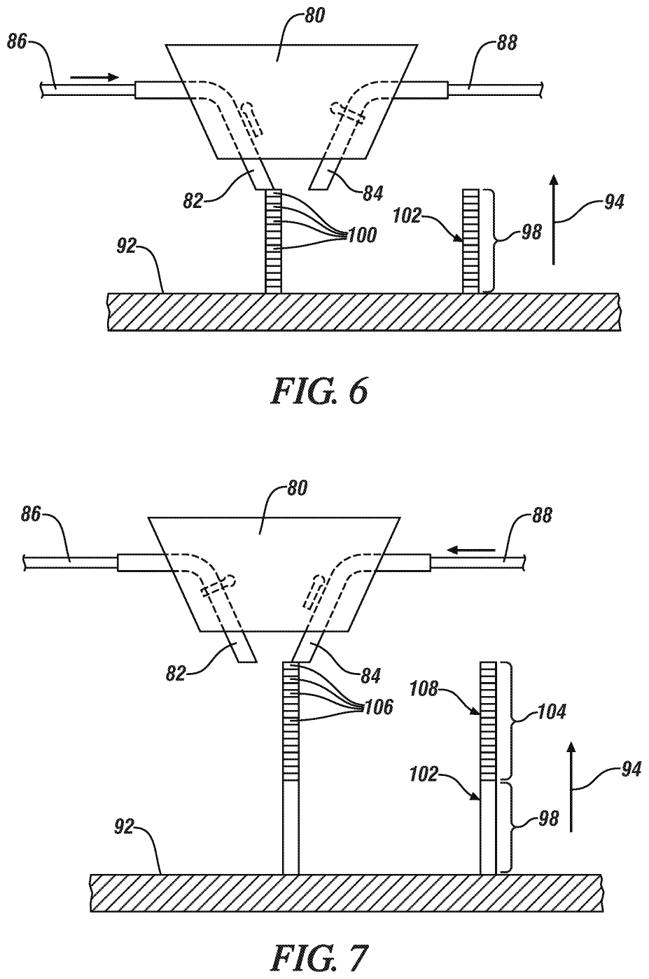

The manufacture of the cylinder liner 66 is illustrated generally in FIGS. 6-8. This process involves first forming a preform 96 (FIG. 9) of the cylinder liner 66. To begin, and referring now to FIG. 6, the first extruder nozzle 82 is rendered operational or active while the second extruder nozzle 84 is temporarily switched off, which can easily be accomplished by valves or other switches. The first cartridge 86 is heated and extruded through the first extruder nozzle 82 while the nozzle head 80 is moved relative to the build surface 92 in a predetermined pattern to consecutively deposit, one after another, each of a first set 98 of cross-sectional layers 100. The first set 98 of cross-sectional layers 100, which is built adjacent to and upwardly from the build surface 92 in the building direction 94, provides a first portion 102 of the preform 96 that includes gas atomized metal particles and/or plasma atomized metal particles. The first portion 102 of the preform 96 is cylindrical in shape. Moreover, each of the deposited layers 100 may have a thickness that ranges from 50 μm to 250 μm and, in this embodiment, anywhere from 100 to 1000 of the layers 100 may be adjacently deposited as a group within the first set 98. When all of the consecutively-deposited cross-sectional layers 100 have been applied, it may be difficult to clearly distinguish the interfaces of the various layers 100.

After the first portion 102 of the preform 96 has been formed, and referring now to FIG. 7, the second extruder nozzle 84 is rendered operational or active while the first extruder nozzle 82 is temporarily switched off. The second cartridge 88 is heated and extruded through the second extruder nozzle 84 while the nozzle head 80 is moved relative to the build surface 92 and the first portion 102 of the preform 96 in a predetermined pattern to consecutively deposit, one after another, each of a second set 104 of cross-sectional layers 106. The second set 104 of cross-sectional layers 106, which is built adjacent to and upwardly from first portion 102 of the preform 96, provides a second portion 108 of the preform 96 that includes water atomized metal particles. As such, the second portion 108 of the preform 96 is cylindrical in shape and is contiguous with the previously-formed first portion 102, while also extending upwardly from the first portion 102 in the building direction 94. Each of the deposited layers 106 may have a thickness that ranges from 50 μm to 250 μm and, in this embodiment, anywhere from 60 to 2500 of the layers 106 may be adjacently deposited as a group within the second set 104. Again, as before, when all of the consecutively-deposited cross-sectional layers 106 have been applied, it may be difficult to clearly distinguish the interfaces of the various layers 106.

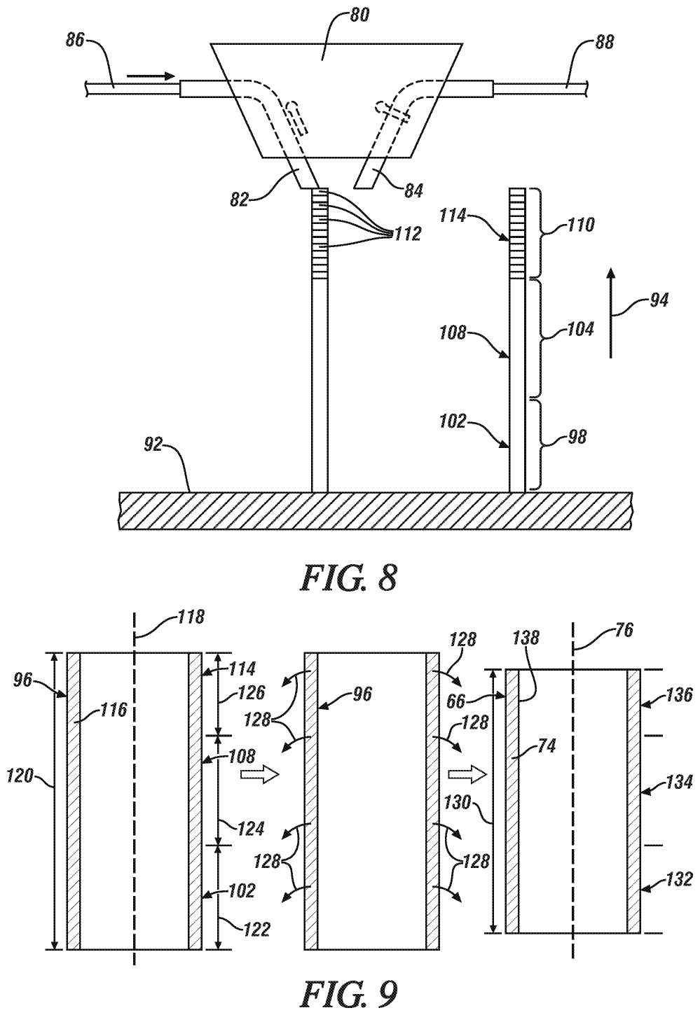

Following the formation of the second portion 108 of the preform 96, and referring now to FIG. 8, the first extruder nozzle 82 is once again rendered operational or active while the second extruder nozzle 84 is temporarily switched off. The first cartridge 86 is again heated and extruded through the first extruder nozzle 82 while the nozzle head 80 is moved relative to the build surface 92 and the first and second portions 102, 108 of the preform 96 in a predetermined pattern to consecutively deposit, one after another, each of a third set 110 of cross-sectional layers 112. The third set 110 of cross-sectional layers 112, which is built adjacent to and upwardly from second portion 108 of the preform 96, provides a third portion 114 of the preform 96 that includes gas atomized metal particles and/or plasma atomized metal particles. As such, the third portion 114 of the preform 96 is cylindrical in shape and contiguous with the previously-formed second portion 108, while also extending upwardly from the second portion 108 in the building direction 94. Each of the deposited layers 112 may have a thickness that ranges from 50 μm to 250 μm and, in this embodiment, anywhere from 100 to 1000 of the layers 112 may be adjacently deposited as a group within the third set 110. The interfaces of the various layers 112 may be difficult to distinguish as before with the other previously-deposited cross-sectional layers 100, 106.

Once all three portions 102, 108, 114 of the preform 96 have been formed, the completed preform 96 is ready for debinding and sintering. The transformation of the preform 96 into the cylinder liner 66 is illustrated in FIG. 9. The preform 96, as shown, now includes a cylindrical wall 116 constituted by the first, second, and third portions 102, 108, 114, and is thus composed of the combined binder material and metal particles contributed by each of the various portions 102, 108, 114. The cylindrical wall 116 circumferentially surrounds a central longitudinal axis 118 and extends axially along that same axis 118 to a length 120. Each of the first, second, and third portions 102, 108, 114 of the preform 96, which are arranged serially along the central longitudinal axis 118 of the preform 96, may also have a length 122, 124, 126, respectively. The length 122, 124, 126 of each portion 102, 108, 114 of the preform 96 is a portion of the overall length 120 of the preform 96. Here, in this embodiment, the lengths 122, 126 of the first and third portions 102, 114 may range from 15% to 30% of the length 120 of the preform 96 while the length 124 of the second portion 108 may range from 40% to 70% of the length 120 of the preform 96. Of course, the lengths 122, 124, 126 of each portion 102, 108, 114 may be larger or smaller than the proportionate ranges just mentioned depending on a number of factors including, for instance, the intended end use of the cylinder liner 66 the compositions of the metal particles in each portion 102, 108, 114 of the preform 96.

The preform 96 is moved away from the bound metal deposition apparatus 78 and subjected to debinding. As mentioned above, this typically involves immersing the preform 96 in a dissolution liquid—examples of which include acetone, heptane, trichloroethylene, or water—to dissolve at least some of the binder material or, alternatively, heating the preform 96 to thermally decompose and drive off at least some of binder material. The removed binding material is depicted in FIG. 9 by reference numeral 128. During debinding, anywhere from 30 wt % to 70 wt % of the binder material included in the preform 96 may be removed. This causes the porosity of the preform to increase, which may or may not be accompanied by shrinkage of the preform 96. Once the debinding procedure is complete, the preform 96 is sintered to obtain the final, 100% metal, monolithic cylinder liner 66. To conduct sintering, the preform 96 is heated—usually in an oven, furnace, or lehr—to fuse the metal particles contained throughout the preform 96 in the solid-state; that is, by way of solid-state softening and diffusion and without liquefaction of the metal particles. The sintering procedure thus causes the preform 96 to densify and shrink as it transitions from the preform 96 into the cylinder liner 66. To that end, a length 130 of the cylinder liner 66 along its central longitudinal axis 76 may be 10% to 25% less than the corresponding length 120 of the preform 96 prior to debinding and sintering.

The monolithic metal cylinder liner 66 includes three distinct regions—namely, a first region 132, a second region 134, and a third region 136—that correspond in relative proportionate sizes and location to the three portions 102, 108, 114 of the preform 96. These regions 132, 134, 136 exist, in part, due to the differences in the shape of the atomized metal particles included in the corresponding regions 102, 108, 114 of the preform 96 and their ability to densify. In particular, during sintering, the metal particles included in each of the portions 102, 108, 114 of the preform 96 fuse and densify, typically to about 95% to 99.8% of the theoretical density of the metal composition of which the particles are composed. The spherical shape of gas atomized and plasma atomized particles permits those particles to generally achieve a higher percentage of theoretical density compared to the water atomized metal particles and their irregular shape. In that regard, a density of each of the first and third regions 132, 136 of the cylinder liner 66, which are derived from gas and/or plasma atomized particles, is different than a density of the second region 134 of the liner 66, which is derived from water atomized metal particles. Specifically, the density of the second portion 134 of the cylinder liner 66 is less than the density of each of the first and third regions 132, 134 of the liner 66, even though the entire liner 66 may be manufactured from steel.

The three regions 132, 134, 136 of the cylinder liner 66 may provide the liner 66 with enhanced performance capabilities. The cylinder liner 66, by its very nature, must have good wear-resistance, so that it can accommodate the high-speed reciprocal sliding action of the piston head 72 (FIG. 4) with minimal friction, while also being able to withstand the heat and pressure developed in the combustion space at the top of the cylinder 70. By using gas and/or atomized metal particles to derive the first and third regions 132, 136 of the cylinder liner 66, the higher attained densities in those regions 132, 136 can provide good mechanical and wear properties where those properties are needed most. The ability to produce gas and plasma atomized particles in an inert atmosphere can also prevent those particles from becoming oxidized, which, in turn, can help ensure that the first and third regions 132, 136 are formed from high-quality atomized metal particles that further promote good mechanical and wear properties. By using water atomized metal particles to derive the second region 134 of the cylinder liner 66, which is disposed between the first and third regions 132, 136 of the liner 66, the lower attained density in that region 134 is better equipped to receive and retain a lubricant to provide a better friction response between an inner circumferential surface 138 of the liner 66 and the reciprocating piston 72. The cylinder liner 66 is thus able to achieve an optimized balance between high mechanical and wear resistance on one hand, and good friction response on the other hand, to realize better overall performance.

The fabrication of the cylinder liner 66 using the presently-disclosed bound metal deposition process described above is one example of how an article with discernible regions having varying metal compositional, physical, and/or mechanical properties can be additively manufactured. The same general process may be applied to a host of other articles, including other automotive component parts, to achieve discernible regions optimized for the particular function of those other articles as well. Moreover, the specific bound metal deposition process described above is subject to some variation without compromising its ability to fabricate the cylinder liner 66 or any other article. For example, rather than using separate first and second extruder nozzles 82, 84 to deposit cross-sectional layers comprised of the first extrudable deposition medium and the second extrudable deposition medium, respectively, a single extruder nozzle may be used instead. In such a scenario, cartridges of the first extrudable deposition medium and the second extrudable deposition medium could simply be exchanged for each other whenever a change in the extrudable deposition medium deposited by the single extruder nozzle is desired. Accordingly, the above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of additively manufacturing a monolithic metal article having a three-dimensional shape, the method comprising:
forming a preform of the article that includes atomized metal particles bound together by a binder material, the atomized metal particles comprising (1) water atomized metal particles and (2) gas atomized metal particles, plasma atomized metal particles, or a mixture of gas atomized metal particles and plasma atomized metal particles;
removing at least some of the binder material from the preform; and
sintering the preform to remove any remaining binder material and to fuse the metal particles together in the solid state to thereby densify and transform the preform into the monolithic metal article.

2. The method set forth in claim 1, wherein the water atomized metal particles are composed of one of steel, iron, iron-carbon alloy, aluminum alloy, cobalt alloy, copper, brass, bronze, tin, zinc, cadmium, tungsten, titanium, or rhenium, and wherein the gas atomized metal particles, plasma atomized metal particles, or the mixture of gas atomized metal particles and plasma atomized metal particles are composed of one of steel, iron, iron-carbon alloy, aluminum alloy, cobalt alloy, copper, brass, bronze, tin, zinc, cadmium, tungsten, titanium, or rhenium.

3. The method set forth in claim 2, wherein the water atomized metal particles and the gas atomized metal particles, plasma atomized metal particles, or the mixture of gas atomized metal particles and plasma atomized metal particles are composed of the same metal.

4. The method set forth in claim 2, wherein the water atomized metal particles and the gas atomized metal particles, plasma atomized metal particles, or the mixture of gas atomized metal particles and plasma atomized metal particles are composed of different metals.

5. The method set forth in claim 1, wherein the monolithic metal article is an automotive component part selected from the group consisting of a cylinder liner, an intake valve, an exhaust valve, a piston, a connecting rod, a piston ring, an engine block, a transmission housing, a gear shaft, a sleeve, and a washer.

6. The method set forth in claim 1, wherein forming the preform comprises:
depositing a first set of consecutive cross-sectional layers of the preform to form a first portion of the preform, each of the cross-sectional layers of the first set being deposited from a first extrudable deposition medium;
depositing a second set of consecutive cross-sectional layers of the preform to form a second portion of the preform adjacent to and contiguous with the first portion of the preform, each of the cross-sectional layers of the second set being deposited from a second extrudable deposition medium;
wherein the first extrudable deposition medium or the second extrudable deposition medium comprises water atomized metal particles, and wherein the other of the first deposition medium or the second deposition medium comprises gas atomized metal particles, plasma atomized metal particles, or a mixture of gas atomized metal particles and plasma atomized metal particles.

7. The method set forth in claim 6, wherein forming the preform further comprises:
depositing a third set of consecutive cross-sectional layers of the preform to form a third portion of the preform adjacent to and contiguous with the second portion of the preform, each of the cross-sectional layers of the third set being deposited from the first extrudable deposition medium or from a third extrudable deposition medium that is different from the first and second extrudable deposition mediums.

8. A method of additively manufacturing a monolithic metal article having a three-dimensional shape, the method comprising:
forming a preform of the article by consecutively depositing a plurality of cross-sectional layers of the preform to thereby build the preform layer-by-layer upwardly from a build surface, the preform comprising atomized metal particles bound together by a binder material and, further, the preform including a first portion and a second portion that is adjacent to and contiguous with the first portion, wherein the first portion or the second portion comprises water atomized metal particles, and the other of the first portion or the second portion comprises gas atomized metal particles, plasma atomized metal particles, or a mixture of gas atomized metal particles and plasma atomized metal particles;
removing at least some of the binder material from the preform; and
sintering the preform to remove any remaining binder material and to fuse the metal particles together in the solid state to thereby densify and transform the preform into the monolithic metal article.

9. The method set forth in claim 8, wherein forming the preform comprises:
depositing a first set of consecutive cross-sectional layers of the preform to form the first portion of the preform, each of the cross-sectional layers of the first set being deposited from a first extrudable deposition medium;
depositing a second set of consecutive cross-sectional layers of the preform to form the second portion of the preform, each of the cross-sectional layers of the second set being deposited from a second extrudable deposition medium;
wherein the first extrudable deposition medium or the second extrudable deposition medium comprises water atomized metal particles, and wherein the other of the first deposition medium or the second deposition medium comprises gas atomized metal particles, plasma atomized metal particles, or a mixture of gas atomized metal particles and plasma atomized metal particles.

10. The method set forth in claim 9, wherein forming the preform further comprises:
depositing a third set of consecutive cross-sectional layers of the preform to form a third portion of the preform adjacent to and contiguous with the second portion of the preform, each of the cross-sectional layers of the third set being deposited from the first extrudable deposition medium or from a third extrudable deposition medium that is different from the first and second extrudable deposition mediums.

11. The method set forth in claim 8, wherein each of the plurality of cross-sectional layers of the preform has a thickness ranging from 50 μm to 250 μm.

12. The method set forth in claim 8, wherein the monolithic metal article includes a first region derived from the first portion of the preform and a second region derived from the second region of the preform, the first region of the metal article having a density that is different from a density of the second region of the metal article.

13. A method of additively manufacturing a monolithic metal article having a three-dimensional shape, the method comprising:
forming a preform of the article that includes metal particles bound together by a binder material, wherein forming the preform further comprises:
depositing a first set of consecutive cross-sectional layers of the preform to form a first portion of the preform, each of the cross-sectional layers of the first set being deposited from a first extrudable deposition medium;
depositing a second set of consecutive cross-sectional layers of the preform to form a second portion of the preform adjacent to and contiguous with the first portion of the preform, each of the cross-sectional layers of the second set being deposited from a second extrudable deposition medium;
wherein the first extrudable deposition medium or the second extrudable deposition medium comprises water atomized metal particles, and wherein the other of the first deposition medium or the second deposition medium comprises gas atomized metal particles, plasma atomized metal particles, or a mixture of gas atomized metal particles and plasma atomized metal particles;
removing at least some of the binder material from the preform by immersing the preform in a dissolution liquid or by heating the preform; and
sintering the preform to remove any remaining binder material and to fuse the metal particles together in the solid state to thereby densify and transform the preform into the monolithic metal article.

14. The method set forth in claim 13, wherein the water atomized metal particles are composed of one of steel, iron, iron-carbon alloy, aluminum alloy, cobalt alloy, copper, brass, bronze, tin, zinc, cadmium, tungsten, titanium, or rhenium, and wherein the gas atomized metal particles, plasma atomized metal particles, or the mixture of gas atomized metal particles and plasma atomized metal particles are composed of one of steel, iron, iron-carbon alloy, aluminum alloy, cobalt alloy, copper, brass, bronze, tin, zinc, cadmium, tungsten, titanium, or rhenium.

15. The method set forth in claim 13, wherein the monolithic metal article includes a first region derived from the first portion of the preform and a second region derived from the second region of the preform, the first region of the metal article having a density that is different from a density of the second region of the metal article.
